(19) United States
(12) Patent Application Publication
(10) Pub. No.: US 2010/0082599 A1
(43) Pub. Date: Apr. 1, 2010

(54) Characterizing Queries To Predict Execution In A Database

(76) Inventors: Goetz Graefe, Madison, WI (US); Archana Sulochana Ganapathi, Palo Alto, CA (US); Harumi Anne Kuno, Cupertino, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/242,678

(22) Filed: Sep. 30, 2008

(51) Int. Cl. G06F 7/10; G06F 17/30

(52) U.S. Cl. 707/713; 707/E17.014

(57) ABSTRACT

One embodiment is a method that obtains query plans for queries in the workload. The query plans include a tree of operators and estimated cardinalities for nodes in the tree. The method then groups the operators for the queries and characterizes the workload in terms of grouped operators to predict performance of the queries before the queries execute in a database.

### CROSS-REFERENCE TO RELATED APPLICATIONS

This application relates to commonly assigned U.S. patent applications having attorney docket number HP 200704074-1 entitled “Reverse Mapping of Feature Space to Predict Execution in a Database” and filed on Jul. 5, 2008; attorney docket number HP 200704075-1 entitled “Predicting Performance of Executing a Query in Isolation in a Database” and filed on Jul. 5, 2008; attorney docket number HP 200704091-1 entitled “Predicting Performance of Multiple Queries Executing in a Database” and filed on Jul. 5, 2008; attorney docket number HP 200704103-1 entitled “Managing Execution of Database Queries” and filed on Jul. 5, 2008, all of which are incorporated herein by reference.

### BACKGROUND

Business Intelligence (BI) database systems process extremely complex queries upon massive amounts of data. This capability is important to modern enterprises, which rely upon the collection, integration, and analysis of an expanding sea of information.

In BI databases, it is quite difficult to predict in advance the performance characteristics (execution time, resource usage and contention, etc.) of executing a business intelligence workload on a given database system configuration, especially when the workload is executed in multiple streams. Enormous amounts of data are stored in the database, and large variances exist in the amount of data processed for each query. Furthermore, predicting the exact amount of data that will be processed for a given query is challenging. Variances in the times needed to execute individual queries can cause wait time to significantly outweigh execution time for a given query. Such variances add to the difficulty in estimating the time needed to execute a query that will run at the same time as other unknown queries.

Database designers can realize many business benefits if they can accurately predict performance of executing queries in a database. By way of example, database designers can more efficiently design a database system for running workloads of customers. Such databases can more accurately be selected with respect to size, capacity, performance, management, and cost, to name a few examples.

### BRIEF DESCRIPTION OF THE DRAWINGS

FIG. 1 is a diagram showing each query as a vector in accordance with an exemplary embodiment of the present invention.

FIG. 2 is a diagram of a system using a machine learning technique in accordance with an exemplary embodiment of the present invention.

FIG. 3 is a diagram of a system showing prediction through the machine learning technique in accordance with an exemplary embodiment of the present invention.

FIG. 4 is a graph showing predicted versus actual time for test queries in accordance with an exemplary embodiment of the present invention.

FIG. 5 is a flow chart of a training phase for a machine learning technique in accordance with an exemplary embodiment of the present invention.

FIG. 6 is a flow chart of a method for characterizing database workloads to facilitate prediction of their performance characteristics in accordance with an exemplary embodiment of the present invention.

FIG. 7 is a block diagram of an exemplary database system in accordance with an embodiment of the present invention.

FIG. 8 is a block diagram of an exemplary computer system in accordance with an embodiment of the present invention.

### DETAILED DESCRIPTION

Exemplary embodiments in accordance with the present invention are directed to systems and methods for predicting the performance characteristics of executing a database workload.

One embodiment pertains to the management of database systems by estimating the performance characteristics of executing a database workload's queries on a given instance of a database system prior to actually performing the workload. One approach to predicting the performance of a database workload is to use machine learning techniques (MLTs) to develop characterization and correlation functions in such a way that the similarity between the characterizations of two workloads correlates to the similarity between those same two workloads' performance characteristics. One embodiment produces two maps. One map locates workloads according to the similarity between their features, and the other map locates workloads according to their performance characteristics in such a way that two workloads that are co-located on one map will also be co-located on the other map.

Exemplary embodiments provide a system and method for characterizing a database workload based on the analysis of the query plans of the workload. This characterization is determined in terms of the performance characteristics of the algorithms used to implement the operators that make up the query plan. The resource requirements and performance characteristics of the workload are modeled to reflect how performance changes according to a variety of parameters, including accuracy of cardinality predictions, amount of available memory, resource contention, etc.

One embodiment creates a characterization of the performance features of running the queries that comprise the workload in isolation. A machine learning algorithm then creates a characterization function for encoding these characteristics into a workload characterization feature space, a characterization function for encoding workload performance characteristics into a performance features space, and a collocation function. Given any point within the workload characteristics feature space, exemplary embodiments can find the corresponding location in the query performance feature space. The characterization and collocation functions are created so as to support a maximum correlation between locations in the workload characterization and performance features spaces. As such the resource requirements (execution time, resource usage, resource contention, etc.) are estimated for executing business intelligence (BI) workloads on a given database system configuration.

One embodiment is illustrated with the following hypothetical example: Consider a business whose data warehouse now has one hundred times as much data as it had at installation. Queries that used to run in an hour now take days, e.g., to produce monthly global financial results. This business needs a bigger database system configuration: more CPUs, more memory, etc. The business desires to determine how much bigger its database should be expanded. Performance does not scale linearly with system size and is highly dependent on the mix of queries and data that comprise a given workload.

In this hypothetical example, if a new database system is too small, performance will not improve enough and the database will not meet the needs of the customer. On the other hand, if the new system is too powerful, then performance will improve, but the price of the new database system could be greater than a system that more efficiently met the needs of the customer. Further, the new system could be both too expensive and also inappropriate for the customer's workload. For example, purchasing one hundred times more disks and partitioning data across them will not help if poor performance is actually due to insufficient CPU resources.

Exemplary embodiments will enable a user (such as database vendor) to recommend a new system to the business customer of the hypothetical example so the database is neither too large nor too small. Exemplary embodiments predict query and workload performance and resource use so both businesses and database vendors can decide which system configuration meets the needs of the customer.

Prediction methods in accordance with exemplary embodiments support both the initial system sizing problem (for example, which system configuration to buy? what is the minimum amount to spend for satisfactory performance?) and the capacity planning problem (for example, what will happen to performance as more data is added?). These problems are of interest both to database customers and to database system vendors. Furthermore, exemplary embodiments provide good query and workload predictions so users know when their queries will finish, without requiring them to know what else is running in the system.

One embodiment applies a methodology that accurately predicts multiple performance metrics (including elapsed time and resource requirements, such as CPU time, disk I/Os, memory usage, and number of messages) simultaneously. Performance predictions can be made for different numbers of executing queries. For example, one embodiment predicts the performance of individual queries running in isolation, based only on their query plans, which are available before runtime. The queries and their individual predictions can also be used to predict multi-query workload performance.

Exemplary embodiments uses one or more machine learning techniques (MLT) to derive a prediction model for each system configuration from benchmark queries and then make predictions based on the measured performance metrics of previously run queries and workloads. Rather than explicitly modeling hardware performance, one embodiment uses a machine learning technique or algorithm to find correlations between the query plan properties and query performance metrics on a training set of queries and then use these correlations to predict the performance of new queries.

Exemplary embodiments are applicable to any database system and configuration using a variety of workloads and datasets. Further, exemplary embodiments are applicable to a wide range of query sizes (execution times that span milliseconds to hours or longer). Further, many data warehouse vendors support a small set of fixed hardware configurations (e.g., fixed amount of memory per CPU or few choices for the number of CPUs). Since performance varies dramatically from one configuration to another, one embodiment trains and predicts on a separate model for each supported hardware configuration. Predicted performance is then compared for each configuration to determine the optimal system size for a given customer workload. Thus, exemplary embodiments characterize the workload and the system performance simultaneously. This characterization produces a detailed picture of both the queries that make up the workload as well as numerous system performance metrics.

One embodiment uses machine learning techniques to first derive a model based on a training set of previously executed data points (queries) and their measured performance. The technique then predicts performance for unknown (“test”) data points based on this model. Exemplary embodiments then capture the interdependencies among multiple performance metrics and predict them simultaneously using a single model. One embodiment uses a Kernel Canonical Correlation Analysis (KCCA) as the machine learning technique.

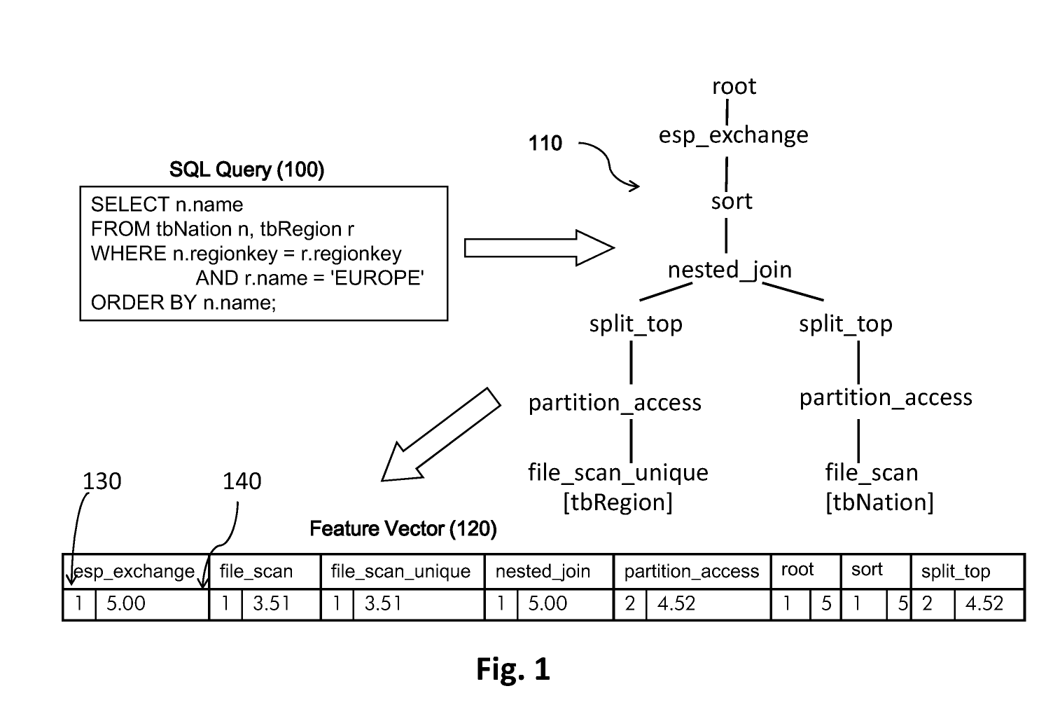

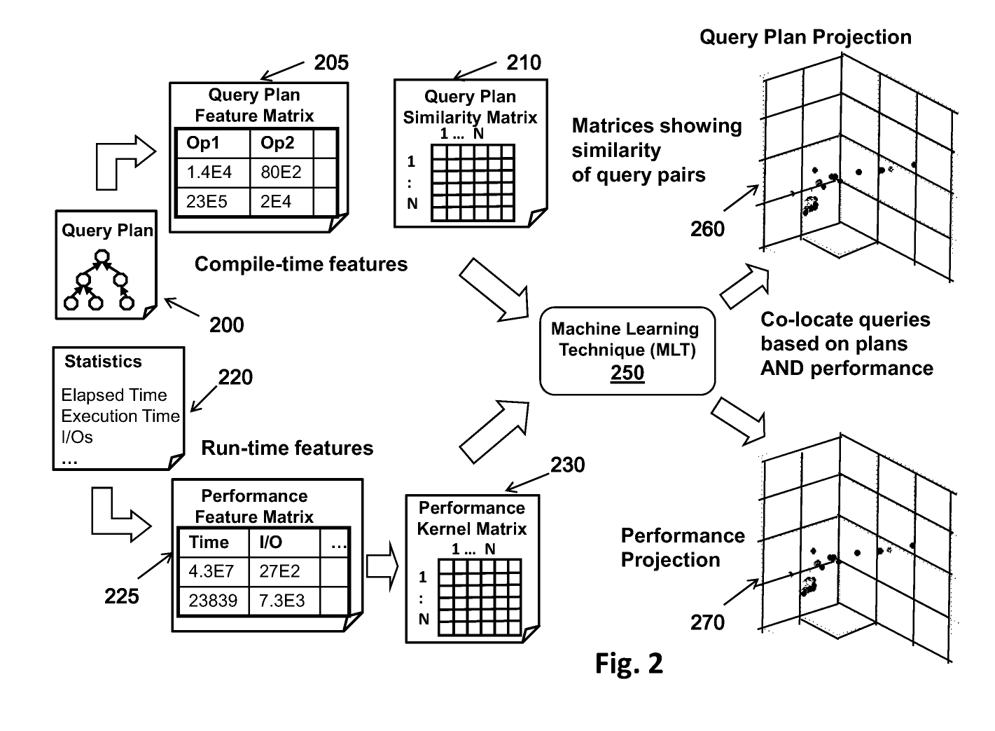

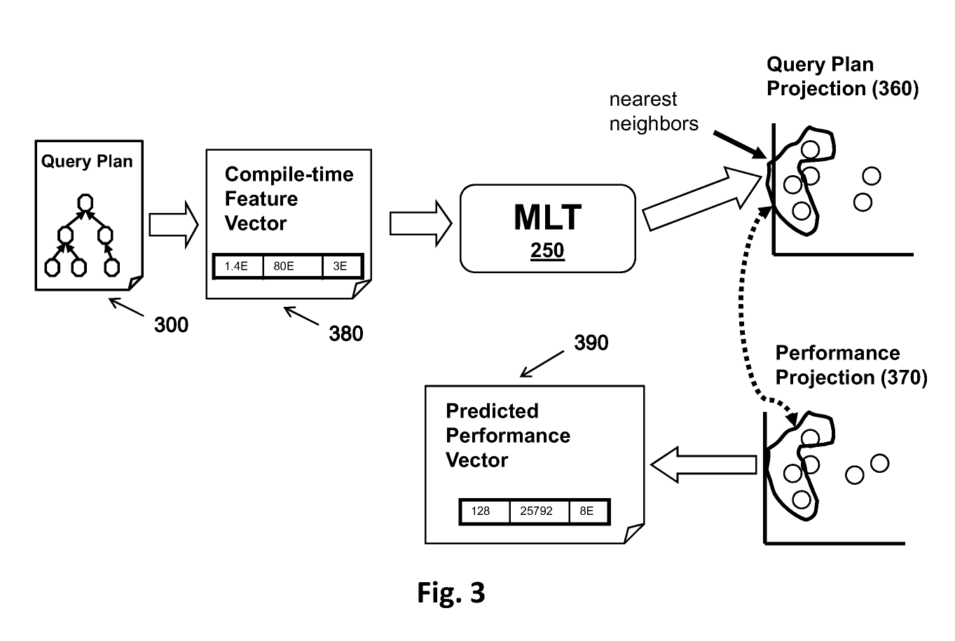

In one embodiment, the machine learning technique predicts query and workload performance. In order to map performance prediction onto the data structures and functions used by the machine learning technique, several issues are explained. First, how exemplary embodiments represent the information about each query available before running it as a vector of “query plan features” and the performance metrics available after running it as a vector of “query performance features.” This explanation is provided in the discussion of FIG. 1. Second, how exemplary embodiments define the similarity between any pair of query plan vectors and any pair of query performance vectors (i.e., define the kernel functions). This explanation is provided in the discussion of FIG. 2. Third, how exemplary embodiments use the output of the machine learning technique to predict the performance of new queries. This explanation is provided in the discussion of FIG. 3.

FIG. 1 is a diagram showing each query as a vector in accordance with an exemplary embodiment of the present invention.

Before running a query 100 (such as an SQL query), the database query optimizer produces or generates a query plan 110 that includes a tree of query operators with estimated cardinalities. This query plan 110 creates a query plan feature vector 120. While an embodiment could use just the query text, two textually similar queries could have dramatically different plans and performance due to different selection predicate constants. The query optimizer's plan, which is produced in milliseconds or seconds, is more indicative of performance and not process intensive to obtain.

The query plan feature vector 120 includes an instance count and cardinality sum for each possible operator. For example, if a sort operator appears twice in a query plan with cardinalities 3000 and 45000, the query plan vector includes a “sort instance count” field containing the value 2 and a “sort cardinality sum” field containing the value 48000. The cardinality sum is the number of rows that the query optimizer predicts will be needed to satisfy the query. FIG. 1 shows the number of instances 130 of the operator in the query (for example, shown as 1 under esp_exchange and 1 under file_scan) and shows the sum of cardinalities 140 for each instance of the operator (for example, shown as 5.00 for esp_exchange and 3.51 for file_scan).

FIG. 1 shows the query plan 110 and resulting feature vector 120 for a simple query (although it omits operators whose count is 0 for simplicity). The intuition behind this representation is that each operator “bottlenecks” on some particular system resource (e.g. CPU or memory) and the cardinality information encapsulates roughly how much of the resource is expected to be consumed. Other features can also be included, such as an indication of tree depth and bushiness.

In one embodiment, a query performance vector is created from the performance metrics that the database system collects when running the query. By way of illustration, such metrics include elapsed time, disk I/Os, message count, message bytes, records accessed (the input cardinality of the file scan operator) and records used (the output cardinality of the file scan operator). In this example, the performance vector would have six elements.

Second, as discussed, exemplary embodiments also define the similarity between any pair of query plan vectors and any pair of query performance vectors (i.e., define the kernel functions). As shown in FIG. 2, a query plan 200 is used to develop or compute a query plan feature matrix 205 and a query plan similarity matrix 210. Further, statistics 220 (such as elapsed time, execution time, disk I/Os, number of messages exchanged, memory usage, etc.) are used to develop or compute a performance feature matrix 225 and a performance kernel matrix 230. The query plan similarity matrix 210 and the performance kernel matrix 230 are input into the machine learning algorithm or technique 250 which generates a query projection plan 260 and a performance projection 270.

In one embodiment, the machine learning technique 250 uses a kernel function to compute a “distance metric” between any two query plan vectors and any two query performance vectors. By way of example, one embodiment uses a Gaussian kernel that assumes only the raw feature values follow a simple Gaussian distribution. The variance in a Gaussian distribution is the standard deviation squared for these values. For example, given N queries, form an N×N matrix L where L(i, j) is the computed similarity between query plan vectors i and j. The query plan kernel matrix is lower-triangular and similarity is normalized to 1, i.e. L(i, j)=1 if i=j. The N×N matrix P of similarity is computed between each pair of query performance vectors (for example, 6-dimensional vectors for the example provided above).

The machine learning technique 250 clusters queries with similar query plan feature vectors and similar performance features vectors. Given matrices L and P of dimension N×N, the machine learning technique finds subspaces of a dimension D<N (D is chosen by the machine learning technique) onto which each can be projected, such that the two sets of projections are maximally correlated. This corresponds to solving a generalized eigenvector problem as shown in FIG. 2. More concretely, the machine learning technique produces a matrix A consisting of the basis vectors of a subspace onto which L is projected (giving L×A), and a matrix B consisting of basis vectors of a subspace onto which P is projected, such that L×A and P×B are maximally correlated.

Third, as discussed, exemplary embodiments also use the output of the machine learning technique to predict the performance of new queries. FIG. 3 is a diagram of a system showing prediction through the machine learning technique in accordance with an exemplary embodiment of the present invention. As shown, the query plan 300 and compile time feature vector 380 are input into the machine learning technique 250 which generates the query plan projection 360 and the performance projection 370. The machine learning technique 350 projects a new query plan vector and then uses nearest neighbors to find the corresponding location on the query performance projection 370 to derive the new query's predicted performance vector 390 from those nearest neighbors.

In one embodiment, predicting the performance of a new query involves two steps. First, exemplary embodiments create its query plan feature vector and identify its coordinates on MLT's query plan projection L×A. Then the k nearest neighbors in the projection (using Euclidean distance) are found from among the known queries. By way of illustration, one embodiment uses k=3, 4, or 5. When k>5, predictions could become skewed by neighbors that are actually too far away.

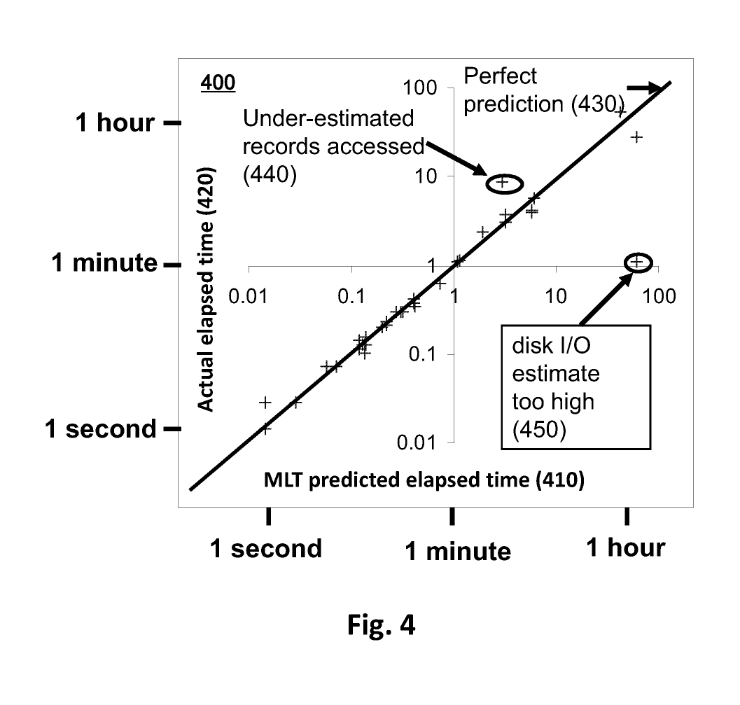

FIG. 4 is a graph 400 showing predicted versus actual time for test queries in accordance with an exemplary embodiment of the present invention. A log-log scale is used to accommodate a wide range of query execution times from milliseconds to hours for fifty four test queries.

The X-axis is labeled as the MLT predicted elapsed time 410, and the Y-axis is labeled actual elapsed time 420. The perfect prediction line 430 shows the predictions with no errors. As shown, the predicted results closely follow the perfect prediction line 430. The closeness of nearly all of the points on the diagonal line (perfect prediction line 430) indicates the accuracy of the predictions. One errant result 440 is the result of an under-estimated of a number of records accessed, and another errant result 450 is a disk I/O estimate that is too high.

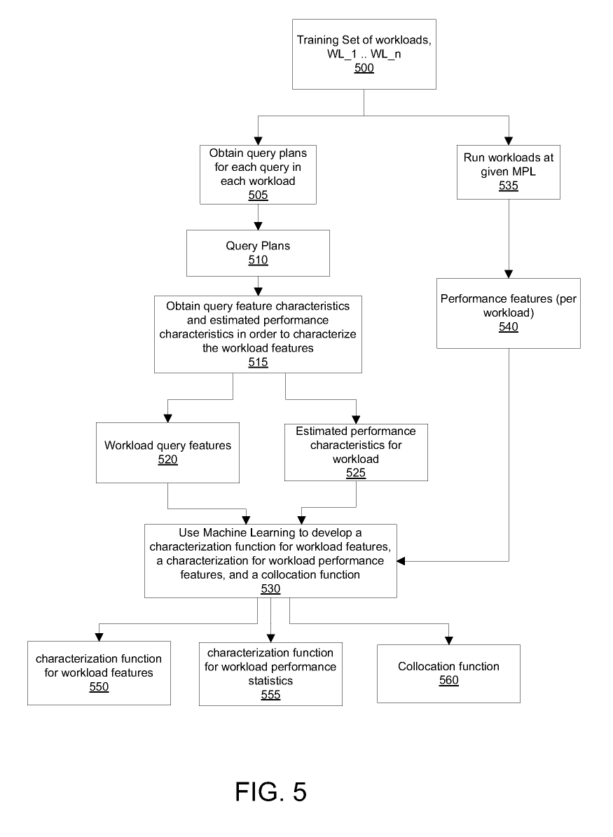

FIG. 5 is a flow chart of an exemplary usage of a system predicting performance of multiple queries executing in a database in accordance with an exemplary embodiment of the present invention.

According to block 500 one or more training sets of representative workloads are obtained and/or identified (for example, a training set of workloads: WL_1, WL_2, . . . WL_n). The data necessary to execute the queries of the workloads is loaded onto the database system configuration.

According to block 505, the query plans (shown in block 510) for each query in each workload is obtained. For each workload in the training set, one embodiment collects the workload's queries' execution plans as well as the performance results of running the queries in isolation on the database system configuration.

According to block 535, the workloads are run or executed at given Multi-Programming Levels (MPLs). The MPLs represent how many queries are simultaneously being executed. If too many queries are simultaneously run, then contention for system resources can degrade system performance. The output from block 535 includes the performance features per workload (shown in block 540), and this data is input in to the machine learning algorithm (shown in block 530).

One embodiment collects performance results for running each workload in its entirety in the database system. Exemplary embodiments then encode the information in each workload's queries' execution plans as a “feature vector.” This feature vector describes the workload and contains, for example, counts and cardinalities for each operator. A similar feature vector is generated for the performance metrics for each query and a feature vector for the performance metrics for each workload. One embodiment derives a workload's feature vector based on the workload's queries' feature vectors and queries' performance metric vectors.

Thus, according to block 515, embodiments obtain query feature characteristics and estimated performance characteristics in order to characterize workload features. The workload query features (shown in block 520) and the estimated performance characteristics for the workload (shown in block 525) are input into the machine learning algorithm (shown in block 530).

According to block 530, exemplary embodiments use machine learning (ML) or a machine learning algorithm (MLA) to develop a characterization function for workload features (shown as output in block 550) and a characterization function for a workload's performance results (shown as output in block 555) in such a way that the similarity between any two workloads' features correlates to the similarity between those same two workloads' performance characteristics. By way of example, this step (in a simple embodiment) produces two maps. One map locates workloads according to their query feature characteristics, and another map locates queries according to their performance characteristics in such a way that two workloads that are co-located on one map will also be co-located on the other map.

One embodiment creates a collocation function (shown as output in block 560) between workload feature characteristics and performance characteristics so that given a location on one map a corresponding location on the other map can be determined.

Given a new workload, one embodiment uses the workload feature characterization function to characterize the new features of the workload and locates it on the workload feature characterization map. The collocation function is used to identify the corresponding location on the performance characteristics map.

As shown in FIG. 5, the machine learning algorithm outputs the characterization function for workload features 550 and the characterization function for workload performance statistics 555.

To develop the characterization functions, exemplary embodiments use a machine learning algorithm (for example, a Kernel Canonical Correlation Analysis: KCCA) with the following procedure.

First, the procedure takes as input a set of vectors representing the workload features and a set of vectors representing the performance metrics. Next, it imposes a notion of “similarity” between two workloads using kernel functions. The procedure performs an equivalent step for comparing performance metrics. The result of this step produces matrices which encode the similarity of each workload in the training set with every other workload in the training set (and similarly for the performance metrics). Next, the procedure uses canonical correlation analysis to identify the dimensions of maximal correlation between the workload features and the performance metrics. The training set data is projected onto these dimensions to generate the maps as previously described. Next, given a new workload, the procedure determines its position on the workload feature map, identifies its nearest neighbors on the map (using any one of a number of methods to calculate distance, such as Euclidean distance or cosine distance), and retrieves the corresponding neighbors on the performance characteristics map to calculate the new workload's performance predictions. For example, an exemplary embodiment can use a simple collocation function that averages the performance metric measurements of the nearest neighbors to produce an estimate of performance metrics for the new point.

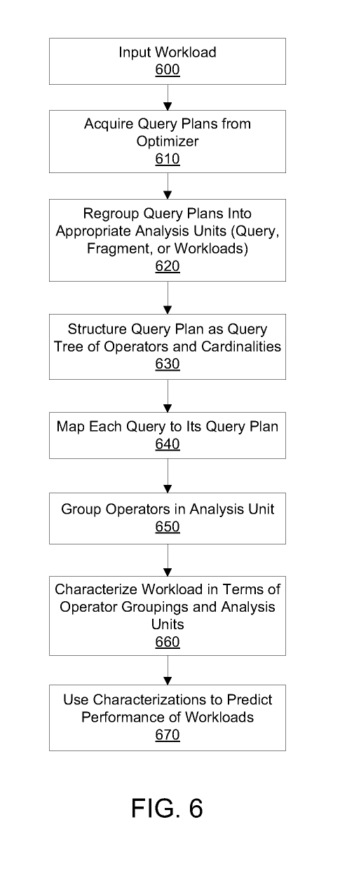

FIG. 6 is a flow chart of a method for characterizing database workloads to facilitate prediction of their performance characteristics in accordance with an exemplary embodiment of the present invention.

According to block 600, a workload for a database is provided. The workload can include a single or multiple queries.

According to block 610, for each query in the workload, the query plans are obtained from the query optimizer.

According to block 620, the query plans are regrouped into appropriate analysis units. By way of example, the query plans are grouped into a unit of queries, fragments, or workloads.

According to block 630, each query plan is structured or transformed into a query tree. The query tree includes operators and cardinalities.

According to block 640, each query in the workload is mapped to its query plan (for example, as shown in FIG. 1). In one embodiment, the query plan includes a tree of operators and estimated cardinalities for each node in the tree. In addition, the query plan can also include additional information about inputs and outputs of each operator, such as the estimated number of rows and estimated byte counts for each input and output. Examples of other information include, but are not limited to, one of more of the following:
(1) CPU_COST: The number of machine instructions that the operator will use to perform its task.
(2) NUM_SEEKS: The number of random Input/Output (I/O) operations and positioning for sequential reads.
(3) NUM_KBYTES: Kilobytes of I/O transferred in reads and writes.
(4) NORMAL_MEMORY: Amount of memory, in kilobytes (KB), used for buffers and tables. All normal memory is returned to the operating system (OS) after the operator is done with its task (i.e. materialize hash table). Most operators' memory usage goes to this bucket.
(5) PERSISTENT_MEMORY: Amount of memory, in KB, used for buffers and tables that persists after the operator is done with its task. For instance, the buffers where rows are maintained in an Extended Stored Procedure (ESP) or master process go to this bucket. Most operators do not use persistent memory.
(6) NUM_LOCAL_MESSAGES: For NT clusters, this value represents the number of messages sent between processes running on different nodes in the cluster (i.e. between different boxes connected via the Local Area Network (LAN) or Servernet). In one embodiment, NT messages that go from a process to another process when both processes are in the same box are not counted as messages, rather they are considered a CPU_COST. For NSK, this value represents the number of messages sent between processes running in different Central Processing Units (CPUs) on the same NSK node.
(7) KB_LOCAL_MESSAGES: Data, in KB, that are sent by local messages.
(8) NUM_REMOTE_MESSAGES: This number is zero in NT. In NSK, this is the number of messages sent from a NSK node to a different NSK node.
(9) KB_REMOTE_MESSAGES: Data, in KB, that are sent by remote messages.
(10) IDLE_TIME: This is mostly used to make blocking addition linear. Most operators do not have to use this bucket, but some use it to put time that the operator spends without being able to do anything else (i.e. ESP initialization, open file in the scans, etc.).
(11) DISK_USAGE: Temporary disk space used by the operator.
(12) NUM_PROBES: If the operator is not under the right child of a nested join this number is one. Otherwise, this number is the number of probes into the operator (i.e. the result cardinality of the nested join operator's left child.)

According to block 650, operators in the query tree are grouped together. For example, group operators implemented using algorithms based on nested loops, algorithms based on sorting, algorithms based on hashing, etc.

According to block 660, characterize the workload in terms of the operator groupings of block 650. One embodiment analyzes the operators and statistics associated with each unit to characterize performance in terms of performance group. A characterization of units in terms of cumulative statistics associated with each performance group is then outputted.

As one example, this characterization involves compiling a count of the number of operators in the workload that fall into each grouping, as well as optionally a characterization of the inputs and outputs associated with those operators. In a second example embodiment, this characterization involves compiling a count of the number of operators per query in the workload that fall into each grouping, as well as optionally a characterization of the inputs and outputs associated with those operators. In a third example embodiment, this characterization involves compiling a count of the number of operators per plan phase in the query plans of the workloads that fall into each grouping, as well as a characterization of the inputs and outputs associated with those operators. Here, “plan phase” means that an embodiment partitions the query plan into sub-trees, divided by blocking operators/algorithms (“stop-and-go” operators such as sort).

In addition, one embodiment associates specific characteristics with operator groupings, such as the dominant resource(s) associated with the underlying algorithm.

According to block 670, the characterizations are used to predict performance of workloads before the workloads actually execute in a database. For example, the characterization is determined in terms of the performance characteristics of the algorithms used to implement the operators that make up the query plan. The resource requirements and performance characteristics of the workload are modeled to reflect how performance changes according to a variety of parameters, including accuracy of cardinality predictions, amount of available memory, resource contention, etc. One embodiment creates a characterization of the performance features of running the queries that comprise the workload in isolation. A machine learning algorithm then creates a characterization function for encoding these characteristics into a workload characterization feature space, a characterization function for encoding workload performance characteristics into a performance features space, and a collocation function. Given any point within the workload characteristics feature space, exemplary embodiments can find the corresponding location in the query performance feature space. The characterization and collocation functions are created so as to support a maximum correlation between locations in the workload characterization and performance features spaces. As such the resource requirements (execution time, resource usage, resource contention, etc.) are estimated for executing business intelligence (BI) workloads on a given database system configuration.

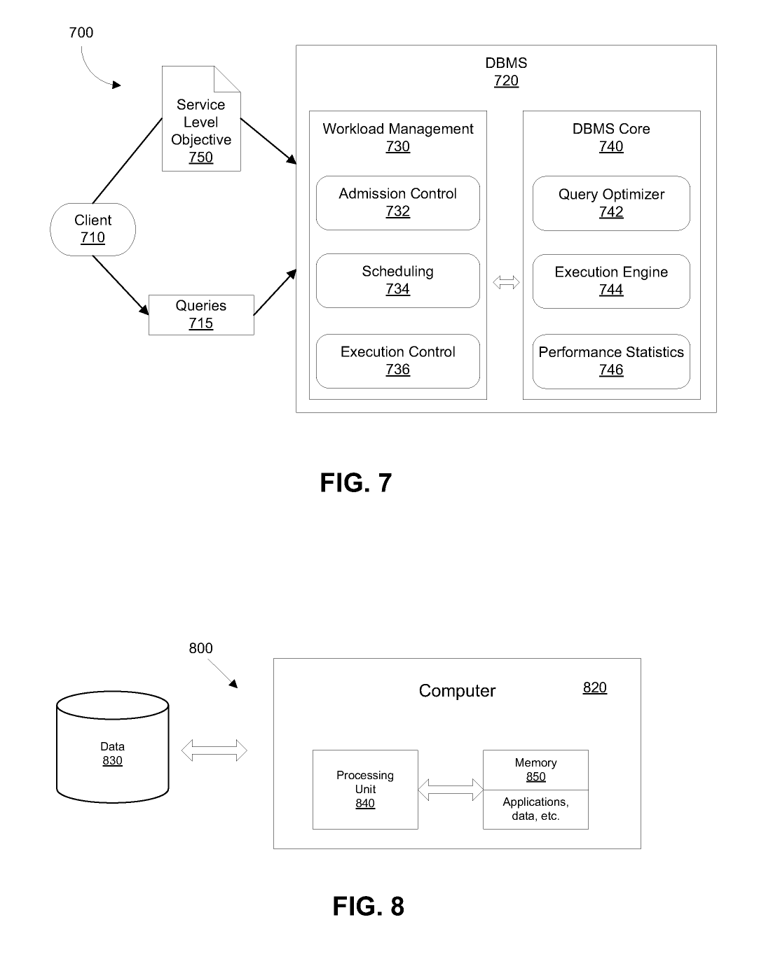

FIG. 7 is a database system 700 for managing the execution of database queries in accordance with an exemplary embodiment of the present invention. The system generally includes a computer or client 710 that sends queries 715 to a Database Management System (DBMS) 720 which includes a workload management component 730 and a DBMS core 740. The workload management component includes plural components or modules as admission control 732, scheduling 734, and execution control 736. The DBMS core 740 includes plural components or modules as a query optimizer 742, an execution engine 744, and performance statistics 746. Further, Service Level Objectives (SLOs) 750 are coupled between the client 710 and the DBMS 720.

The workload management architecture 730 provides fundamental workload management functionality for admission control, scheduling, and execution control. The DBMS core 740 provides core database functionality and supply information to workload management components but does not implement workload management policies. Each job consists of an ordered set of typed queries 715 submitted by a computer or client 710, and is associated with one or more Service Level Objectives (SLOs).

Embodiments in accordance with the present invention are utilized in or include a variety of systems, methods, and apparatus. FIG. 8 illustrates an exemplary embodiment as a computer system 800 for being or utilizing one or more of the computers, methods, flow diagrams and/or aspects of exemplary embodiments in accordance with the present invention.

The system 800 includes a computer 820 (such as a host or client computer) and a repository, warehouse, or database 830. The computer 820 comprises a processing unit 840 (such as one or more processors or central processing units, CPUs) for controlling the overall operation of memory 850 (such as random access memory (RAM) for temporary data storage and read only memory (ROM) for permanent data storage). The memory 850, for example, stores applications, data, control programs, algorithms (including diagrams and methods discussed herein), and other data associated with the computer system 820. The processing unit 840 communicates with memory 850 and data base 830 and many other components via buses, networks, etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Execution time can vary significantly depending on the resource needs of the query and the resource needs of the other queries being executed at the same time. By explicitly predicting and modeling the resource needs of the queries that make up the workload, exemplary embodiments provide a more complete characterization of how the various queries in a given workload interact and thus provide more accurate predictions of the workload's performance characteristics. Exemplary embodiments also includes methods to build a model of how to characterize the queries in the training set so as to create clusters of queries that will be likely to exhibit similar performance characteristics.

With exemplary embodiments, users (such as DBAs and database designers) can predict the time needed to execute one or more queries (i.e., a workload). Exemplary embodiments use machine learning to discover simultaneously (1) a characterization function for characterizing the similarity between workloads as well as (2) a characterization function for characterizing similar performance of workloads, and (3) a mapping function between the resulting workload characteristics and the resulting performance characteristics. Exemplary embodiments provide methods and systems to predict in advance the performance characteristics (for example, execution time, resource usage, resource contention, etc.) of executing multiple queries in a large scale BI database.

Execution time can vary significantly depending on the resource needs of the query and the resource needs of the other queries being executed at the same time. As such, one exemplary embodiment does not focus on predicting the elapsed execution time that a database system will need in order to execute a given database query. Instead, one embodiment provides a more complete characterization of a given query's predicted resource needs.

Further, relationships exist between a static set of query characteristics (e.g., the text of the SQL statement that defines the query, the estimated number of tuples to be processed in the course of the query, etc.) and elapsed execution time. One embodiment learns the relationships between the query characteristics themselves. This learning includes steps to build a model of how to characterize the queries in the training set so as to create clusters of queries that will be likely to exhibit similar performance characteristics.

Exemplary embodiments are applicable for addressing various business needs, and some examples are provided as follows. As one example, embodiments are used to respond to a customer challenge workload: Selecting a database system configuration for running a “challenge” workload given by a customer that falls within the customer's price range yet is capable of executing the workload with at least acceptable performance. As another example, embodiments are used for sizing a database: Selecting a database system configuration to sell to a customer. The system executes the customer's business workload with at least acceptable performance, yet designs a system to be priced within the customer's budget. As yet another example, embodiments consider capacity planning: Given a current customer who has a business workload that they are running on a given database system configuration, embodiments predict what would happen if the characteristics of the database system configuration were changed (e.g., scaled up or scaled down) or if the customer's workload were to change (e.g., if the customer were to scale up, scale down, or change the nature/distribution of their workload), or if both the database system configuration and the customer's workload were to change. As another example, embodiments are used for workload management: Given a workload and a database system configuration, select admission control, scheduling, and execution management policies that enable the workload to be executed on the database system configuration with good performance characteristics. As yet another example, embodiments are used for multi-query optimization: Given a workload and a database system configuration, embodiments characterize how queries will interact when executing simultaneously and improve the performance of executing the workload on the database system configuration. As yet another example, embodiments provide progress indication: Given a currently executing query, embodiments determine its degree of completion and/or rate of progress and can provide this information to a user.

### DEFINITIONS

As used herein and in the claims, the following words have the following definitions:

The terms “automated” or “automatically” (and like variations thereof) mean controlled operation of an apparatus, system, and/or process using computers and/or mechanical/electrical devices without the necessity of human intervention, observation, effort and/or decision.

A “database” is a structured collection of records or data that are stored in a computer system so that a computer program or person using a query language can consult it to retrieve records and/or answer queries. Records retrieved in response to queries provide information used to make decisions. Further, the actual collection of records is the database, whereas the DBMS is the software that manages the database.

A “database administrator” or “DBA” is a person who defines or manages a database or controls access to the database.

A “database management system” or “DBMS” is computer software designed to manage databases.

The term “execution time” means the amount of time the processor or CPU is actually executing instructions. During the execution of most programs, the CPU sits idle much of the time while the computer performs other tasks, such as fetching data from the keyboard or disk, or sending data to an output device. The execution time is, therefore, generally less than the wall-clock time (i.e., the actual time as measured by a clock that the query has been running) and includes the time a query is executing in the database and not the time waiting in a queue.

Given an input data consisting of some number of vectors, the term “feature space” means the space to which all possible input vectors could be mapped. The feature space could have the same dimension as the input space or the dimensionality could be less.

The term “machine learning” means the design and development of algorithms and/or techniques that allow computers to use inductive learning methods to extract rules and/or patterns out of large data sets.

The term “query plan” or “execution plan” means a set of steps used to access information in a database, such as an SQL relational database management system.

The term “Service Level Objective” or “SLO” is a key element of a Service Level Agreement (SLA) between a Service Provider and a customer. SLOs are agreed as a means of measuring the performance of the Service Provider and are outlined as a way of avoiding disputes between the two parties based on misunderstanding. The SLA is the contract or agreement that specifies what service is to be provided, how it is supported, times, locations, costs, performance, and responsibilities of the parties involved. SLOs are specific measurable characteristics of the SLA such as availability, throughput, frequency, response time, or quality. Further, the SLOs can include one or more quality-of-Service (QoS) measurements that are combined to produce the SLO achievement value.

A “workload” is a set of queries used for the data warehouse.

In one exemplary embodiment, one or more blocks or steps discussed herein are automated. In other words, apparatus, systems, and methods occur automatically.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
obtain a query for a database;
acquire for the query a query plan that includes a tree of operators and estimated cardinalities for nodes in the tree;
group together the operators for the query; and
characterize the query in terms of grouped operators and the estimated cardinalities to predict performance of the query before the query executes in the database.

2) The method of claim 1, wherein in the tree further includes information about inputs and outputs of each of the operators.

3) The method of claim 1, wherein the tree further includes an estimated number of rows and an estimated number of byte counts for each of the operators.

4) The method of claim 1, wherein the tree further includes statistics about an estimated number of rows and an estimated number of byte counts for each of the grouped operators and further includes statistics about the estimated number of rows and the estimated number of byte counts for each sub-tree's operator groupings.

5) A tangible computer readable storage medium having instructions for causing a computer to execute a method, comprising:
receiving a workload of queries for a database;
obtaining for each query in the workload a query plan that includes a tree of operators and estimated cardinalities for nodes in the tree;
grouping together the operators for the queries; and
characterizing the workload in terms of grouped operators to predict performance of the queries before the queries execute in the database.

6) The tangible computer readable storage medium of claim 5, wherein the query plan include one from a group including a number of machine instructions an operator will use to perform its task, a number of Input/Output (I/O) operations, an amount of I/O transferred in reads and writes, an amount of memory used for buffers and tables, a number of messages sent between processes running on different nodes, an amount of data sent by local and remote messages, and an amount of temporary disk space used by an operator.

7) The tangible computer readable storage medium of claim 5 further comprising:
generating a first map that locates workloads according to a similarity among features in query plans of the workloads;
generating a second map that locates workloads according to a similarity among performance characteristics, wherein two workloads that are co-located on the first map and also co-located on the second map.

8) The tangible computer readable storage medium of claim 5 further comprising, modeling both resource requirements and performance characteristics of the workload to reflect how performance changes according to parameters that include accuracy of cardinality predictions, amount of available memory, and resource contention.

9) The tangible computer readable storage medium of claim 5, wherein each query plan further includes an estimated number of rows and byte counts for inputs and outputs for each operator.

10) The tangible computer readable storage medium of claim 5, wherein characterizing the workload includes one from a group including compiling a count of a number of operators in the workload, compiling a count of a number of operators per query, and compiling a count of a number of operators per plan phase in the query plans.

11) A database system, comprising:
a database;
a memory for storing an algorithm; and
a processor for executing the algorithm to:
obtain query plans for workloads, each query plan including a tree of operators and estimated cardinalities for nodes in the tree;
group the operators; and
characterize the workload in terms of grouped operators to predict performance of the queries before the queries execute in the database.

12) The computer system of claim 11, wherein each query plan further includes a number of machine instructions that an operator will use to perform a task and an amount of memory used for buffers and tables.

13) The computer system of claim 11, wherein each query plan further includes a number of messages sent between processes running on different nodes in a cluster.

14) The computer system of claim 11, wherein the processor further executes the algorithm to compile a count of a number of operators per query in the workload that fall into each grouping.

15) The computer system of claim 11, wherein the processor further executes the algorithm to characterize the workload based on an analysis of the query plans in the workload.
